(19) United States
(12) Patent Application Publication
(10) Pub. No.: US 2012/0151823 A1
(43) Pub. Date: Jun. 21, 2012

(54) Bed Bug Detector

(75) Inventors: Bruce Donoho, Mission Viejo, CA (US); Robert D. Fish, Tustin, CA (US)

(73) Assignee: BIRD-B-GONE, INC., Mission Viejo, CA (US)

(21) Appl. No.: 12/969,270

(22) Filed: Dec. 15, 2010

(51) Int. Cl. A01M 1/10

(52) U.S. Cl. 43/123

(57) ABSTRACT

Various embodiments of bed bugs detectors are shown having a housing with a first sloped surface and a second sloped surface. The first sloped surface can be disposed about at least part of an exterior of the housing, and the second sloped surface can be disposed to define a perimeter of a trap. The detector can include one or more lures that are configured to attract bed bugs. The first slope surface can have one or more channels configured to direct a flow of carbon dioxide to an exterior of the detector.

### FIELD OF THE INVENTION

The field of the invention is bed bug detectors.

### BACKGROUND

Various insect traps are known in which an insect enters and then cannot escape. See, e.g., U.S. Pat. No. 2,167,978 to Jennerich; U.S. Patent Appl. no. 2005/0138858 to Lyng (publ. June 2005); and U.S. Patent Appl. no. 2008/0017775 to Gary (publ. January 2008). These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

It is also known to have traps that can be placed about a table or bed post to prevent bed bugs from crawling up the post and on to the bed or table. See, e.g., U.S. Patent Appl. no. 2009/0282728 to McKnight, et al. (publ. November 2009). While such traps can be useful, they can be unsightly when placed about a bed or table post, and typically rely on a sleeping human as a lure rather than include a lure within the trap itself.

U.S. Patent Appl. no. 2007/0044372 to Lang et al. (publ. March 2007); U.S. Patent Appl. no. 2008/0168703 to Siljander et al. (publ. July 2008); U.S. Patent Appl. no. 2009/0145020 to McKnight, et al. (publ. June 2009); and U.K. Patent Appl. no. 2458194 to Brandenburg (UK) Ltd. (publ. September 2009) describe various traps including one or more lures to attract bed bugs. However, such traps suffer from one or more disadvantages.

Thus, there is still a need for improved bed bug detectors that overcome disadvantages of the prior art.

### SUMMARY OF THE INVENTION

The inventive subject matter provides apparatus, systems and methods in which a bed bug detector includes a housing that has a first sloped surface disposed about at least a portion of the housing's exterior, and a second sloped surface that defines an outer perimeter of a trap. The first sloped surface can advantageously include one or more gas channels along which the flow of carbon dioxide can be directed. The gas channel(s) preferably direct the carbon dioxide to an exterior of the trap, which can prevent the carbon dioxide flowing from the trap in all directions, and thereby reduces the amount of carbon dioxide needed. As used herein, the term “gas channel” means a channel through which carbon dioxide can be directed.

Preferred detectors have one or more lures, which can include, for example, heat sources, carbon dioxide sources, or any other commercially suitable lure(s). Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Contemplated carbon dioxide sources include, for example, a carbon dioxide (CO₂) canister, dry ice, and any other commercially suitable sources. Contemplated heat sources include, for example, a heating coil and any other commercially suitable sources.

Preferably, the first sloped surface is composed of a fibrous material that can act as an attractant for bed bugs, although any commercially suitable material(s) could be used.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIGS. 1-5 are vertical cross-sectional views of various embodiments of a bed bug detector.

FIG. 6 is a top view of an embodiment of a bed bug detector, and

FIG. 7 is a perspective view of the bed bug detector of FIG. 6.

FIG. 8 is a top view of another embodiment of a bed bug detector.

FIG. 9 is a vertical cross-section of another embodiment of a bed bug detector.

### DETAILED DESCRIPTION

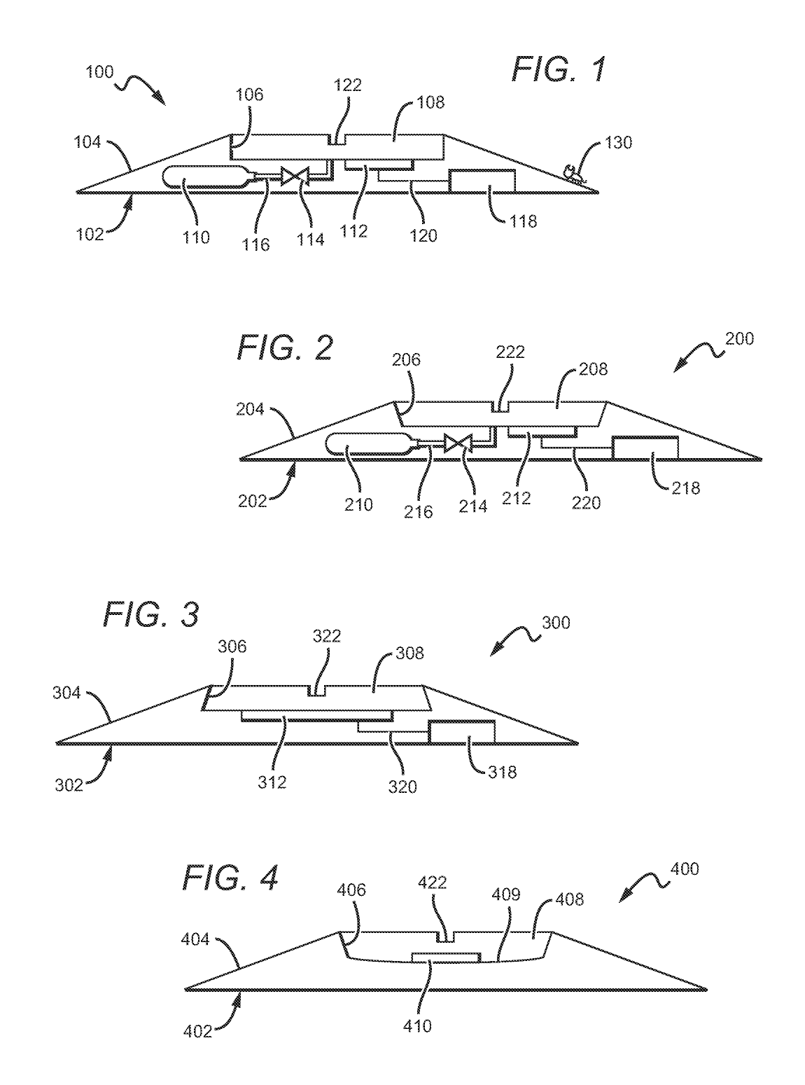

In FIG. 1, a bed bug detector 100 is shown having a housing 102 that includes first and second sloped surfaces 104 and 106, respectively. The first sloped surface 104 is preferably disposed about an exterior portion of the detector 100, although it is contemplated that the first sloped surface 104 might not include the outermost surface of the detector 100. As used herein, the phrase “disposed about” includes “formed within”. For example, the first sloped surface can be integral with the detector 100 or a separate piece.

In preferred embodiments, the second sloped surface 106 defines the boundary or perimeter of a trap 108 within the detector 100, and preferably has a downward slope of at least 70 degrees. As shown in FIG. 1, the second surface 106 has a downward slope of about 90 degrees, although greater and lesser slopes are contemplated, so long as a bed bug 130 is prevented from ascending the second sloped surface 106. As used herein, the term “about” means within 5% of the recited value.

Housing 102 and the first sloped surface 104 can each comprise any commercially suitable material(s) including, for example, plastics and other polycarbonates, metals and metal composites, rubber, silicone, wood and other fibrous materials, and any combination(s) thereof. However, the first sloped surface 104 advantageously comprises a fibrous material, which can act as an additional lure for bed bugs. The second sloped surface 106 is preferably composed of one or more relatively smooth material(s), which prevents the bed bug from climbing up the second sloped surface 106 and out from trap 108. Such materials can include, for example, glass, vinyl plastic, and other commercially suitable material(s).

The detector 100 preferably includes one or more lures configured to attract bed bugs to the detector 100, and that are disposed within the detector 100. As used herein, the term “disposed within the detector” means disposed inside of the detector or supported by the detector. The lures can include, for example, a CO₂ canister 110 or other commercially suitable source of carbon dioxide, a heat source 112, and any other commercially suitable lure(s). Carbon dioxide from the CO₂ canister 110 can flow through a valve 114 to the trap 108 via conduit 116. The valve 114 can be used to restrict the flow of CO₂ from the canister 110, or eliminate the flow of CO₂ entirely, as desired. Valve 114 can include a restrictor portion, a ball valve, a gate valve, or any other commercially suitable valve. In this instance, and where other upper limits are not expressly stated, the reader should infer a reasonable upper limit. In this instance, for example, a commercially reasonable upper limit is about 5 lures.

Preferably, the CO₂ source 110 comprises a standard screw-in CO₂ canister having 8 g of CO₂, although other sizes of canisters could alternatively be used. In this manner, a small CO₂ cartridge or other source can be used to provide a sufficient level of CO₂ in the atmosphere surrounding the detector 100 to lure bed bugs 130, while maintaining a supply of CO₂ for overnight use. It is currently preferred that the flow rate of the CO₂ is less than 2 ml/min, and preferably less than 1.5 ml/min. Of course, high flow rates (e.g., 20 ml/min or greater) are contemplated, but such flow rates would require larger CO₂ sources. For example, a 16 g CO₂ canister can emit CO₂ at a rate of 2 ml/min for a period of about 74 hours, and an 8 g CO₂ canister can emit CO₂ at a rate of 2 ml/min for a period of about 37 hours.

Heat source 112 can include, for example, a heating coil, although any commercially suitable heat source(s) could be used. The heat source 112 can be coupled to a battery compartment 118 by wire 120. Alternatively, the heat source 112 can be coupled to a line voltage or other power source.

The first sloped surface 104 can include one or more gas channels 122 that can direct a flow of carbon dioxide to an exterior of the detector 100. By directing carbon dioxide along specific paths rather than allow the carbon dioxide to flow in every direction, the detector 100 concentrates the CO₂ at specific locations and thereby reduces the amount of CO₂ needed. Without channel 122, the reduced amount of carbon dioxide would be less effective in luring bed bugs to the trap, as the CO₂ would flow over the entire first sloped surface 104, and would diffuse prior to reaching the exterior of the housing 102. The channels 122 can also act as an additional lure for bed bugs that prefer to crawl within the channel 122 rather than along the first sloped surface 104.

In currently preferred embodiments, the channels 122 have a width of between 2-10 mm, a depth of between 2-10 mm, and a length of between 15-100 mm. Of course, the actual dimensions of the channels 122 will depend upon the number of channels, the flow rate of the carbon dioxide, and the size and dimension of the detector 100.

It is contemplated that a bed bug 130 would be attracted to the detector 100 by the CO₂ canister 110, the heat source 112, or other commercially suitable lure(s), and would scale the first sloped surface 104 or channel 122 until the bed bug 130 reaches the second sloped surface 106. As the bed bug 130 moves toward the lure(s), the bed bug 130 will slide, fall, or otherwise descend into the trap 108 from which it cannot escape at least in part because of the slope of the second sloped surface 106 and its smooth surface.

FIG. 2 illustrates another embodiment of a bed bug detector 200 having a housing 102 that includes first and second sloped surfaces 204 and 206, respectively. The second sloped surface 206 defines a boundary of a trap 208 within the detector 200, and has a downward slope of about 70 degrees. As used herein, the term “within the detector” means enclosed in the detector or otherwise supported by the detector. With respect to the remaining numerals in FIG. 2, the same considerations for like components with like numerals of FIG. 1 apply.

FIG. 3 illustrates yet another embodiment of a bed bug detector 300 having a housing 302 that includes first and second sloped surfaces 304 and 306, respectively. The second sloped surface 306 defines a boundary of a trap 308 within the detector 300, and has a downward slope of about 120 degrees.

The detector 300 can have a heat source 312 configured to attract bed bugs to the detector 300. The heat source 312 can comprise a heating coil or any other commercially suitable heat source. The heat source 312 can be coupled to a battery compartment 318 by wire 320. Alternatively, the heat source 312 can be coupled to a line voltage such as by a standard power plug. Alternatively or additionally, the detector 300 can have a CO₂ source or other commercially suitable lure. With respect to the remaining numerals in FIG. 3, the same considerations for like components with like numerals of FIG. 1 apply.

In FIG. 4, an embodiment of a bed bug detector 400 is shown, which has a housing 402 that includes first and second sloped surfaces 404 and 406, respectively. In preferred embodiments, the first sloped surface 404 comprises a fibrous material, and the second sloped surface 406 comprises a material has a surface roughness of less than 2.5 μm. The second sloped surface 406 preferably defines a boundary of a trap 408 within the detector 400, and has a downward slope of about 70 degrees. The trap 408 can include a curved bottom surface 409.

The detector 400 can include dry ice 410 as a CO₂ source, although any commercially suitable CO₂ source could be used. With respect to the remaining numerals in FIG. 4, the same considerations for like components with like numerals of FIG. 1 apply.

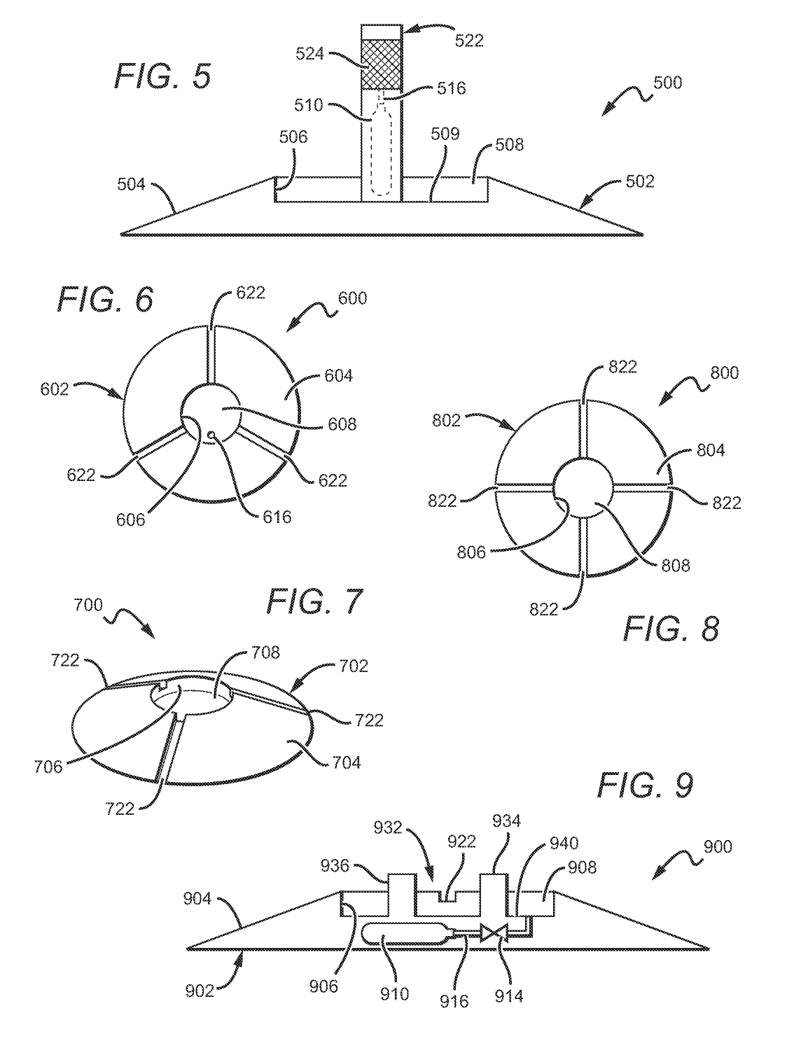

FIG. 5 illustrates another embodiment a bed bug detector 500 having a housing 502 that includes first and second sloped surfaces 504 and 506, respectively. The second sloped surface 506 defines an outer boundary of a single trap 508 within the detector 500, and has a downward slope of about 90 degrees.

A CO₂ source 510 can be placed within the trap 508 such that carbon dioxide can be emitted as a lure for bed bugs. The source 510 can be placed within a lure housing 522 that extends upwards from a bottom surface 509 of trap 508. The lure housing 522 can include a screen 524 to restrict entry into the lure housing 522. In some contemplated embodiments, the lure housing 522 can have an outer surface that is relatively smooth (e.g., a surface roughness of less than 2.5 μm) to prevent the ascent of bed bugs. With respect to the remaining numerals in FIG. 5, the same considerations for like components with like numerals of FIG. 1 apply.

In FIG. 6, a top view of another embodiment of a bed bug detector 600 is shown that includes three channels 622 disposed along the first sloped surface 604. While the three channels 622 are shown as equidistant to one another, it is also contemplated that the channels 622 could have varying distances from one another. It is further contemplated that the channels 622 could have different widths, and/or could have varying widths along the lengths of the channels 622. In currently preferred embodiments, the channels 622 are sized and dimensioned such that bed bugs can crawl along the channels 522 toward trap 608. With respect to the remaining numerals in FIG. 6, the same considerations for like components with like numerals of FIG. 1 apply.

FIG. 7 shows a perspective view of a bed bug detector 700 having three channels 722 disposed along the first sloped surface 704. Preferably, the depth of the channels 722 is less than the depth of the trap 708, such that bed bugs cannot crawl out from the trap 708 once inside. With respect to the remaining numerals in FIG. 6, the same considerations for like components with like numerals of FIG. 1 apply.

FIG. 8 illustrates yet another embodiment of a bed bug detector 800 having four channels 822 disposed along the first sloped surface 804. With respect to the remaining numerals in FIG. 8, the same considerations for like components with like numerals of FIG. 1 apply.

In FIG. 9, another embodiment of a bed bug detector 900 is shown having a first trap 908 that surrounds an inner area 932 of the detector 900. Preferably a projection 934 raised from floor 940 has a ring- or other shaped surface that divides the trap 908 into an inner area 932 and an outer area (trap 908). In especially preferred embodiments, the projection 934 can have a maximum height that is greater than a maximum height of the top of the second sloped surface 906. This advantageously ensures that CO₂ can flow toward an exterior surface of the detector 900 rather than toward the inner area 932. In addition, the projection 934 advantageously reduces the volume of the trap 908 such that less CO₂ is required to fill trap 908 before CO₂ can flow out from trap 908, preferably along channel(s) 922.

The outer surface 936 of the projection 934 can have a smooth surface such that bed bugs are prevented from ascending the outer surface 936. Alternatively, talcum powder or other formulation can be coated on the outer surface 936 to create a smooth surface. In still other alternative embodiments, the outer surface 936 can have a surface roughness that allows bed bugs to ascend the outer surface 936 and climb into the inner area 932. For example, if a user wanted to place a bed post within the inner area 932, the outer surface 936 preferably has a smooth surface such that bed bugs are prevented from reaching the inner area and from climbing the bed post. However, if the detector 900 is placed underneath a bed or other location, the outer surface 936 could have a surface roughness to allow bed bugs to climb the outer surface 936 and reach the inner area 932, which thereby increases the capacity of the detector 900.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A bed bug detector having a trap, comprising:
a housing having a first sloped surface and a second sloped surface;
a lure comprising at least one of a heat source and a carbon dioxide source;
wherein the first sloped surface is disposed about at least a portion of an exterior of the housing, and includes a gas channel; and
wherein the second sloped surface that defines a perimeter of the trap, and has a downward slope of at least 70 degrees.

2. The bed bug detector of claim 1, wherein the lure comprises the heat source.

3. The bed bug detector of claim 1, wherein the lure comprises the carbon dioxide source.

4. The bed bug detector of claim 3, wherein the carbon dioxide source comprises a CO₂ canister.

5. The bed bug detector of claim 3, wherein carbon dioxide flows from the carbon dioxide source at a rate of approximately 2 ml/min.

6. The bed bug detector of claim 1, wherein the carbon dioxide source comprises dry ice.

7. The bed bug detector of claim 1, wherein the lure comprises both the heat source and the carbon dioxide source.

8. The bed bug detector of claim 1, wherein the second sloped surface has a downward slope of at least 90 degrees.

9. The bed bug detector of claim 1, wherein the first sloped surface comprises a fibrous material.

10. The bed bug detector of claim 1, wherein the first sloped surface includes at least three gas channels.

11. The bed bug detector of claim 1, wherein the trap has a floor, and further comprising a projection disposed within the trap that is raised above the floor.

12. The bed bug detector of claim 11, wherein a maximum height of the projection is greater than a maximum height of the second sloped surface.
